(19) United States
(12) Patent Application Publication
(10) Pub. No.: US 2009/0028987 A1
(43) Pub. Date: Jan. 29, 2009

(54) Sliding Valve for an Injection Nozzle

(75) Inventor: Gerri CONDO, Hillsburgh (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/828,366

(22) Filed: Jul. 26, 2007

(51) Int. Cl. B29C 39/24

(52) U.S. Cl. 425/564; 264/299

(57) ABSTRACT

A shut-off valve assembly for an injection unit is provided. It includes a first valve body, defining a portion of a channel, and a second valve body, defining a second portion of the channel, the second valve body being slidable relative to the first valve body. A plunger having an orifice therethrough, is located between the first valve body and the second valve body, and is selectively movable between an open position where the orifice is aligned with the channel and a closed position where the orifice is misaligned with the channel. Compressing the first valve body and the second valve body together while the plunger is in the open position creates a positive face seal around the orifice, thereby reducing leakage in the shut-off valve assembly.

### FIELD OF INVENTION

The present invention generally relates to molding systems; more specifically, the present invention relates to sliding valves for the injection nozzle for the molding system.

### BACKGROUND OF INVENTION

The injection molding process usually comprises preparing a polymeric material in an injection unit of an injection molding machine, injecting the now-molten material under pressure into a closed and clamped mold that is water cooled, solidifying the material in its molded shape, opening the mold and ejecting the part before beginning the next cycle. The polymeric material typically is supplied to the injection unit from a hopper in the form of pellets or powder. The injection unit transforms the solid polymeric material into a molten material, typically using a feed screw, which is then injected into a hot runner system under pressure from the feed screw or a plunger unit. A shut off valve assembly is typically provided to stop and start the flow of molten material from the barrel to the hot runner.

Numerous types of shut-off valve assemblies can be used, including sliding piston valves and rotary valves. An example of a prior art sliding piston valve assembly for an injection unit can be found in U.S. Pat. No. 4,140,238 to Dawson (published 1979 Feb. 20). An example of a prior art rotary valve assembly for an injection unit can be found in U.S. Pat. No. 4,054,273 to Neuman (published 1977 Oct. 18).

Efforts have been made to improve the slide valve assembly. Japanese patent 57120407A2 (published 1982 Jul. 27) teaches a method to remove the hardened material attached to the resin inlet of a mold and also prevent resin dripping from the resin outlet, thus intend automation of sealing operation, by providing a sliding plate with a connecting port between the resin inlet of the mold and the resin outlet and moving the resin pouring port. Resin is poured into a cavity 3 by making at first a slide hole 11 to coincide with a valve port 15 by operating a pneumatic cylinder 12, pressing the resin from an inlet 17 and making the resin to pass through the valve port 15, the slide hole 11 and a runner 4 by pulling an opening and shutting rod 14. Then, after standing it for predetermined time till the resin hardens, connection between the runner 4 and the valve port 15 is shut by moving a sliding plate 10 due to operation of the pneumatic cylinder 12, further the sealing resin 16 is blocked by pushing the opening and shutting rod 14 to shut the valve port 15 and the hardened material at the inlet 5 of the mold is cut off by the slide hole 11. By this, resin dripping can be prevented, though the pouring port is disconnected from the mold.

U.S. patent application Ser. No. 11/454,015 to Gaillard (filed on 2006 Jun. 15) teaches springs, discs, cylinders or other device that are used to create an axial force AF between the components, which move with respect to each other. In order to facilitate movement between the components, a clearance is provided between the components. To avoid leakage or weepage from exiting the clearance, the collar and springs are incorporated between the components. The collar is designed to receive the axial force AF and redirect at least a portion of the axial force AF to a radial force RF. This radial force RF acts on an inner portion of the collar forcing the inner portion tightly into engagement with one of the two components, thereby sealing off the clearance or an area adjacent the clearance where leakage or weepage may occur

### SUMMARY OF INVENTION

According to a first broad aspect of the present invention, there is provided a shut-off valve assembly for an injection unit is provided. It includes a first valve body, defining a portion of a channel, and a second valve body, defining a second portion of the channel, the second valve body being slidable relative to the first valve body. A plunger having an orifice therethrough, is located between the first valve body and the second valve body, and is selectively movable between an open position where the orifice is aligned with the channel and a closed position where the orifice is misaligned with the channel. Compressing the first valve body and the second valve body together while the plunger is in the open position creates a positive face seal around the orifice.

According to a second broad aspect of the present invention, there is provided a method for injecting a working fluid through a shut-off valve assembly, comprising the steps of:

moving a plunger in the shut-off valve assembly from a closed position to an open position; the plunger defining an orifice therethrough, the orifice being aligned with the channel when the plunger is in the open position, and misaligned with the channel when the plunger is in the closed position; and

compressing together a first valve body defining a portion of the channel, and a second valve body defining a second portion of the channel, thereby creating a positive face seal around the orifice;

pressurizing the working fluid so that the working fluid is expressed through a nozzle at an end of the shut-off valve assembly;

stopping the expression of the working fluid through the nozzle;

decompressing the first and second valve body; and

moving the plunger from the open position to the closed position.

### DETAILED DESCRIPTION OF DRAWINGS

A better understanding of the non-limiting embodiments of the present invention (including alternatives and/or variations thereof) may be obtained with reference to the detailed description of the non-limiting embodiments of the present invention along with the following drawings, in which

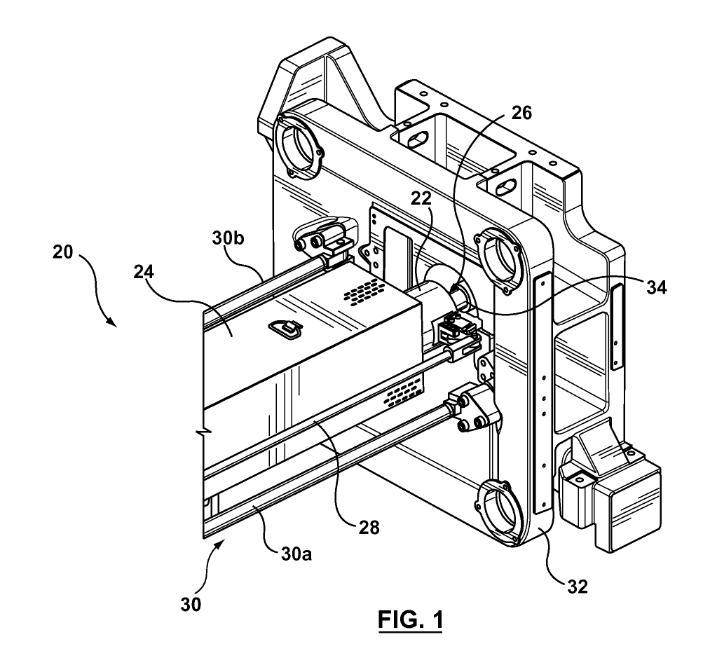

FIG. 1 shows a perspective view of a portion of an injection unit for a molding system in accordance with a first non-limiting embodiment of the invention;

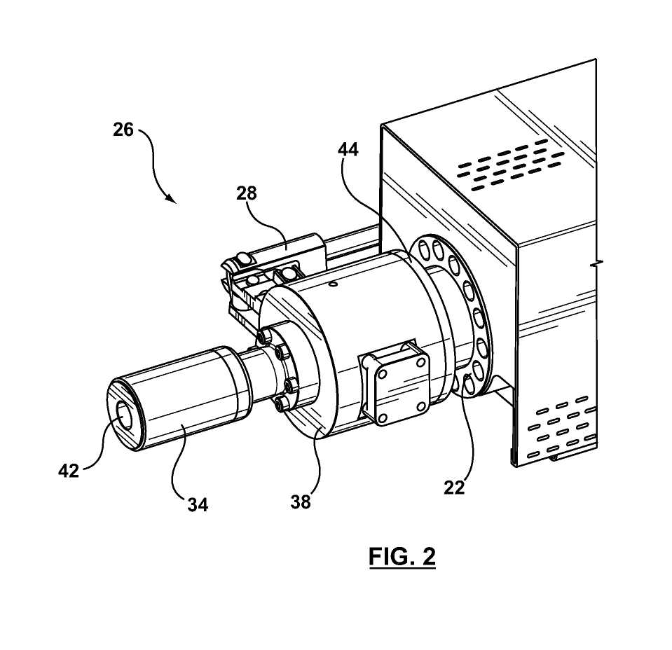

FIG. 2 shows a perspective view of a shut-off valve assembly for the injection unit shown in FIG. 1;

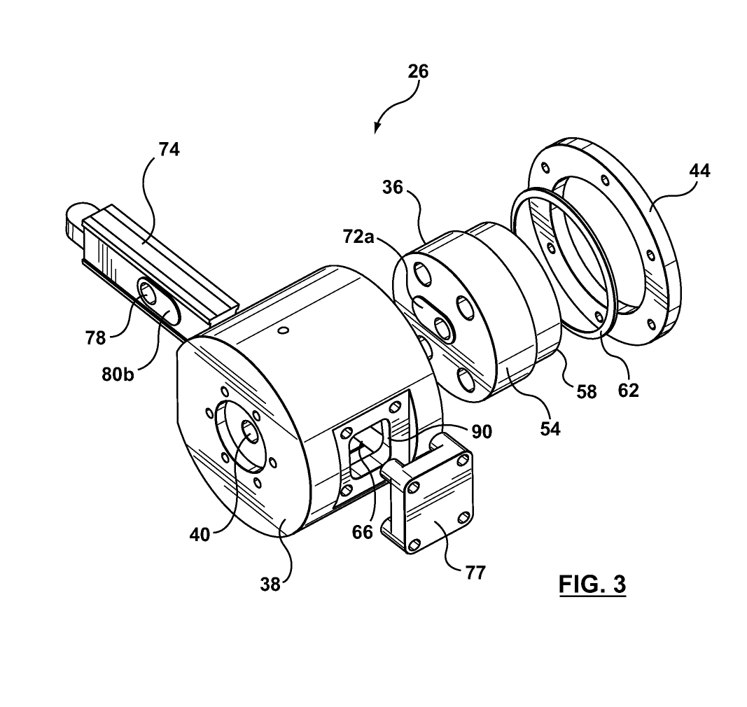

FIG. 3 shows an exploded view of the shut-off valve assembly shown in FIG. 2;

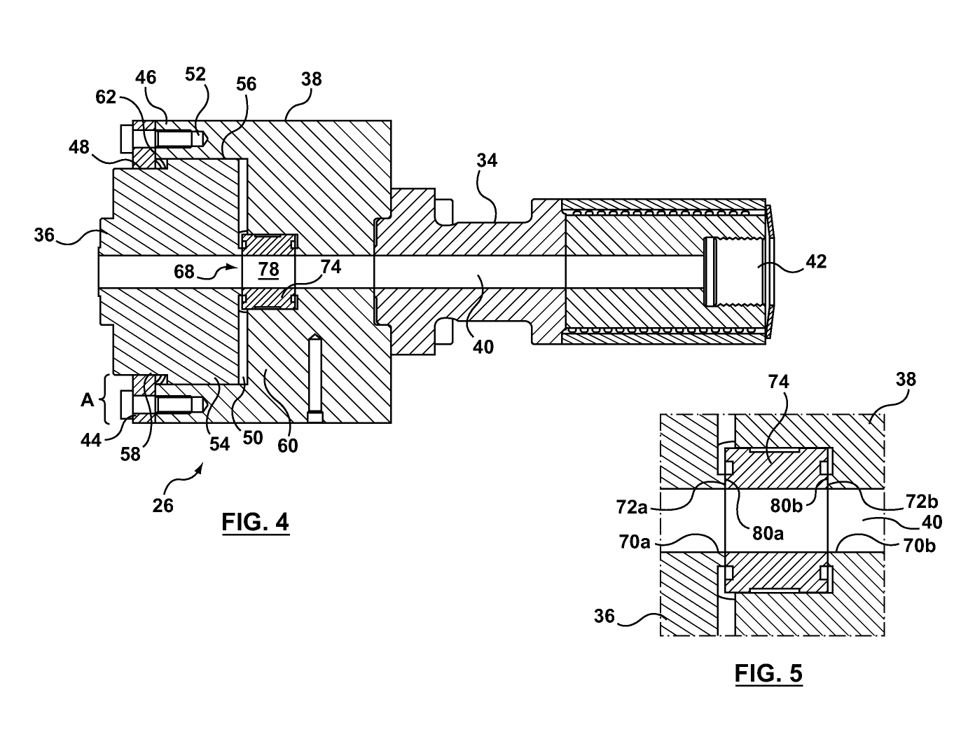

FIG. 4 shows a side cross-sectional view of the shut-off valve assembly shown in FIG. 2;

FIG. 5 shows a close-up cross sectional view of a plunger for the shut-off valve assembly shown in FIG. 2;

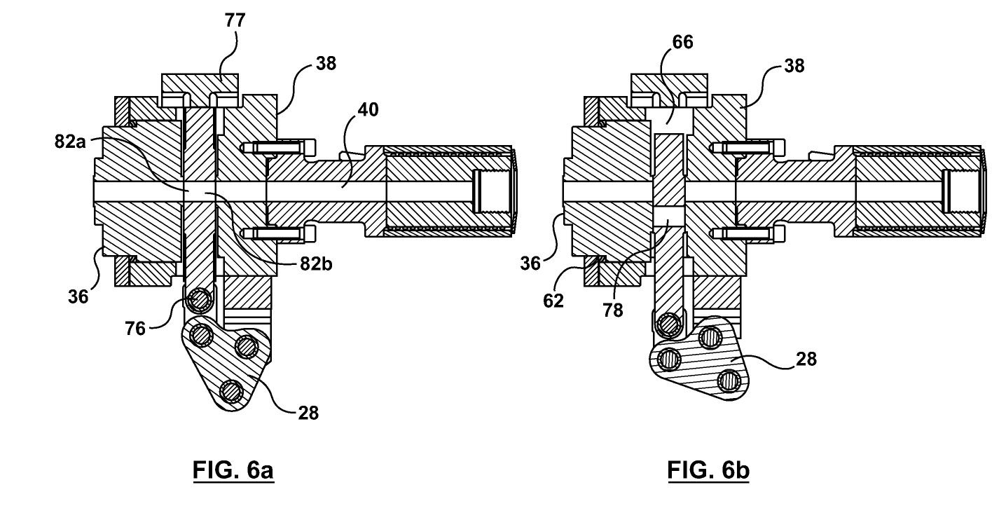

FIG. 6a shows a top cross-sectional view of the shut-off valve assembly shown in FIG. 2, in the open position; and

FIG. 6b shows a top cross-sectional view of the shut-off valve assembly shown in FIG. 2, in the closed position.

### DETAILED DESCRIPTION OF THE NON-LIMITING EMBODIMENTS

Referring now to FIG. 1, a portion of an injection unit for a molding system is shown generally at 20. The injection unit 20 includes an extrusion barrel 22 (FIG. 2) adapted to receive a screw (not shown), located with a barrel housing (also not shown) under heat shield 24. A shut-off valve assembly 26 is located at an end of extrusion barrel 22, and is operable to selectively open or close via a linkage assembly 28, which in turn is operably connected to an actuator (not shown). At least one carriage cylinder 30 is attached to injection unit 20, and is selectively operable to move the injection unit 20 towards or away from a fixed platen 32. In the presently-illustrated embodiment, a pair of carriage cylinders 30a and 30b are provided, with one on each side of injection unit 20 When moved towards fixed platen 32, a nozzle 34 on the end of shut-off valve assembly 26 interfaces with a main melt channel on a hot runner assembly (neither shown) that is mounted to fixed platen 32 on the side opposite injection unit 20. When shut-off valve assembly 26 is open, a working fluid, typically a molten material such as a PET resin is expressed from extrusion barrel 22 through shut-off valve assembly 26, and then out through a nozzle 34 and into the hot runner assembly.

Referring now to FIGS. 2-6, shut-off valve assembly 26 is described in greater detail. Shut-off valve assembly 26 includes a first valve body and a second valve body. In the illustrated embodiment, the first valve body, namely barrel-head extension 36 is mounted to an end of the extrusion barrel 22. Also in the illustrated embodiment, the second valve body, namely shut-off head 38 is slidably mounted around the barrel-head extension 36, and is described in greater detail below. The invention is not limited to barrel-head extensions and shut-off heads, and other first and second valve bodies will occur to those of skill in the art. The nozzle 34 is mounted at the end of shut-off head 38. Barrel-head extension 36, shut-off head 38 and nozzle 34 are all coaxially aligned with extrusion barrel 22, and cooperatively define a channel 40 between them. The molten material is expressed through channel 40 from extrusion barrel 22, exiting through an outlet 42 on nozzle 34.

An annular retaining plate 44 is located between extrusion barrel 22 and shut-off head 38. Retaining plate 44 is mounted to shut-off head 38 via fasteners 52. Retaining plate 44 is sized to have an annular width (A) so that a flange portion 48 of the retaining plate 44 extends inwards past the cylinder wall 46 of shut-off head 38.

A cylindrical chamber 50 is defined in shut-off head 38 that is open towards extrusion barrel 22. Barrel-head extension 36 is slidably located substantially within cylindrical chamber 50. Barrel-head extension 36 includes several stepped cylindrical portions, with a first portion 54 sized to slidably fit against a sidewall 56 on cylindrical chamber 50 (best seen in FIG. 4), and a second portion 58 sized smaller than first portion 54 so as to slidably fit through the aperture defined by the retaining plate 44. As such, the sliding movement of barrel-head extension 36 is delimited by an end wall 60 on shut-off head 38 and by the flange portion 48 of the retaining plate 44. A spring 62 is located around second portion 58 between retaining plate 44 and a step 64 on barrel-head extension 36 which urges barrel-head extension 36 towards end wall 60.

A slot 66 is defined between shut-off head 38 and barrel extension 36 that is generally traverse to, and intersects with channel 40. Slot 66 is bounded on all sides by sidewalls 90, but includes an open face 68 within end wall 60. In the presently-illustrated embodiment, slot 66 is generally rectangular in cross-section, but other geometrical cross-sections, including cylindrical cross-sections are within the scope of the invention.

A first face surface 72a is formed on the barrel-head extension 36 facing towards the slot 66, and a second face surface 72b is formed on an opposite side of the slot 66. As is best seen in FIG. 5, first face surface 72a and second face surface 72b are each formed on a first raised portion 70a and a second raised portion 70b, respectively, which extend into slot 66 on opposing sides of channel 40.

A plunger 74 is sized to be slidably located within slot 66. Plunger 74 is sandwiched between barrel-head extension 36 and shut-off head 38, and secured in place with retaining plate 44. Spring 62 ensures there is always positive surface pressure on the plunger 74 from both barrel-head extension 36 and shut-off head 38. In the presently-illustrated embodiment, plunger 74 is generally rectangular in cross-section, but other geometrical cross-sections, including cylindrical cross-sections are within the scope of the invention. A first end 76 of plunger 74 is attached to the linkage assembly 28 for movement within slot 66 between an “open” position (FIG. 6a) and a “closed” position (FIG. 6b). A cap 77 is mounted to shut-off head 38 over slot 66 to delimit motion of plunger 74 in a first direction, and the linkage assembly 28 delimits the motion of plunger 74 in a second direction. An orifice 78 is defined extending fully through plunger 74, having a first end 82a open towards barrel-head extension 36, and a second end 82b open towards shut-off head 38.

Plunger 74 is moved by an actuator (not shown) via linkage assembly 28. The implementation of the actuator is not particularly limited, but can be electric, hydraulic, or pneumatic. When plunger 74 is in the open position (FIG. 6a), orifice 78 is aligned to be coaxial with channel 40, permitting the throughput of molten material. A first mated face portion 80a abuts against first face surface 72a, and a second mated face portion 80b abuts against second face surface 72b to provide a positive face seal around both ends 82a and 82b of orifice 78 to prevent leakage of molten material into slot 66. When plunger 74 is in the closed position (FIG. 6b), orifice 78 is located out of channel 40, so that plunger 74 prevents the molten material from flowing. The mated face portion 80a and 80b continues to abut against first face surface 72a and second face surface 72b. Spring 62 ensures there is always positive surface pressure on the interface between each of the first face surface 72a and second face surface 72b, and their respective mated face portions 80a or 80b. Although the presently-illustrated embodiment shows a sliding plunger 74, the plunger could also move between the open and closed positions via rotation.

Before the start of an injection phase in injection unit 20, the carriage cylinders 30a and 30b move the injection unit 20 so that the nozzle 34 firmly abuts against the fixed platen 32. Plunger 74 is actuated to the open position via linkage assembly 28. Before the molten material is injected from extrusion barrel 22, the carriage cylinders 30a and 30b apply a compressive force to the shut-off valve assembly 26 against the fixed platen 32 (between the extrusion barrel 22 and the nozzle 34). The first face surface 72a and the first mated face portion 80a are pressed together, creating an effective face seal over first end 82a. The second face surface 72b and the second mated face portion 80b are pressed together, creating an effective face seal over second end 82b, thus ensuring that there is no separation between the plunger 74 and the shut-off head 38 or barrel-head extension 36, thereby reducing leakage. Alternatively, an auxiliary actuator (not shown) could be used to apply a compressive force between barrel-head extension 36 and shut-off head 38 to create an effective face seal

After the injection phase is complete, a hold phase occurs so that plunger 74 is left in the open position, with carriage cylinders 30a and 30b continuing to keep shut-off valve assembly 26 under high pressure.

After the injection and hold phases of the molding cycle are complete, the carriage cylinders 30a and 30b are relaxed, removing pressure from the face seal areas. Plunger 74 is freed to move by reducing the pressure of the carriage cylinders 30a and 30b sufficiently to allow plunger 74 to slide and be returned to the closed position via the actuation of linkage assembly 28. Alternatively, plunger 74 could be returned to the closed position via other means such as a return spring (not depicted), or a dedicated plunger actuator (also not depicted). Once plunger 74 reaches the closed position, the carriage cylinders 30a and 30b are again energized, the face seal pressure rises, and the injection recovery portion of the cycle occurs. Finally, with the end of recovery, the carriage cylinders 30a and 30b are again relaxed, the plunger 74 is shifted to the open position, and the cycle starts again. The spring 62 ensures there is positive surface pressure on the face-seal interfaces while plunger 74 is moving (i.e., when carriage cylinders 30a and 30b are not energized). It also allows for injection recovery when purging the injection unit.

Non-limiting embodiments of the present invention may provide a shut-off valve assembly having reduced leakage over prior art shut-off valve assemblies. Non-limiting embodiments of the present invention may provide a shut-off valve assembly having reduced resin scorching over prior art shut-off valve assemblies. Non-limiting embodiments of the present invention may provide a shut-off valve assembly having reduced actuation requirements over prior art shut-off valve assemblies.

The description of the non-limiting embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. Therefore, what is to be protected by way of letters patent are limited only by the scope of the following claims.

What is claimed is:

1. A shut-off valve assembly for an injection unit, comprising:
a first valve body, defining a portion of a channel;
a second valve body, defining a second portion of the channel, the second valve body being slidable relative to the first valve body;
a plunger having an orifice therethrough, the plunger being located between the first valve body and the second valve body, and further being selectively movable between an open position where the orifice is aligned with the channel and a closed position where the orifice is misaligned with the channel; and
wherein compressing the first valve body and the second valve body together while the plunger is in the open position creates a positive face seal around the orifice.

2. The shut-off valve assembly of claim 1, wherein a portion of the first valve body that faces towards the plunger defines a first face surface.

3. The shut-off valve assembly of claim 1, wherein a portion of the second valve body that faces towards the plunger defines a second face surface.

4. The shut-off valve assembly of claim 2, wherein a mated face portion of the plunger faces towards the first face surface when the plunger is in the open position.

5. The shut-off valve assembly of claim 3, wherein a second mated face portion of the plunger faces towards the second face surface when the plunger is in the open position.

6. The shut-off valve assembly of claim 2, wherein a mated face portion of the plunger faces towards the first face surface when the plunger is in the closed position.

7. The shut-off valve assembly of claim 3, wherein a second mated face portion of the plunger faces towards the second face surface when the plunger is in the closed position.

8. The shut-off valve assembly of claim 1, wherein a slot is defined between the first valve body and the second valve body, the slot being adapted to slidably retain the plunger

9. The shut-off valve assembly of claim 8, wherein the first valve body includes a raised portion extending into the slot, the raised portion defining a first face surface.

10. The shut-off valve assembly of claim 8, wherein the second valve body includes a second raised portion extending into the slot, the second raised portion defining a second face surface.

11. The shut-off valve assembly of claim 9, wherein a mated face portion on the plunger abuts against the first face surface on the first valve body while the plunger is in both the open position and the closed position, thereby creating the positive face seal around a first end of the orifice.

12. The shut-off valve assembly of claim 10, wherein a second mated face portion on the plunger abuts against the second face surface on the second valve body while the plunger is in both the open position and the closed position, thereby creating the positive face seal around a second end of the orifice.

13. The shut-off valve assembly of claim 1, wherein one of the first valve body and the second valve body is concentrically mounted over a portion of the other of the first valve body and the second valve body.

14. The shut-off valve assembly of claim 8, wherein a spring urges the first valve body and the second valve body to constrict the width of the slot, thereby creating the positive face seal between each of the first valve body and the second valve body and the plunger.

15. The shut-off valve assembly of claim 1, wherein the first valve body and the second valve body are compressed together during an injection phase of the injection unit.

16. The shut-off valve assembly of claim 1, wherein the first valve body and the second valve body are compressed together during a hold phase of the injection unit.

17. The shut-off valve assembly of claim 1, wherein the first valve body and the second valve body are compressed together via at least one carriage cylinder engaged to apply a force through the shut-off valve assembly.

18. The shut-off valve assembly of claim 17, wherein the plunger is operable to move between the open position and the closed position while the at least one carriage cylinder is disengaged.

19. The shut-off valve assembly of claim 1, wherein the plunger is moved between the open position and the closed position by an actuator.

20. The shut-off valve assembly of claim 1, wherein the first valve body is a barrel-head extension.

21. The shut-off valve assembly of claim 1, wherein the first valve body is a shut-off head.

22. An injection unit for a molding system, including the shut-off valve assembly described in claim 1.

23. A molding system, having an injection unit operable to deliver a molten material to a runner assembly mounted to a fixed platen, the injection unit having a shut-off valve assembly as described in claim 1.

24. A method for injecting a working fluid through a channel in a shut-off valve assembly, comprising:
moving a plunger in the shut-off valve assembly from a closed position to an open position; the plunger defining an orifice therethrough, the orifice being aligned with the channel when the plunger is in the open position, and misaligned with the channel when the plunger is in the closed position; and
compressing together a first valve body defining a portion of the channel, and a second valve body defining a second portion of the channel, thereby creating a positive face seal around the orifice;
pressurizing the working fluid so that the working fluid is expressed through a nozzle at an end of the shut-off valve assembly;
stopping the expression of the working fluid through the nozzle;
decompressing the first valve body and the second valve body; and
moving the plunger from the open position to the closed position.
